(19) United States
(12) Patent Application Publication
(10) Pub. No.: US 2011/0001651 A1
(43) Pub. Date: Jan. 6, 2011

(54) Zero standby power laser controlled device

(76) Inventors: Brant L. Candelore, San Diego, CA (US); Robert Blanchard, Escondido, CA (US); Peter Rae Shintani, San Diego, CA (US)

Correspondence Address: MILLER PATENT SERVICES, 2500 DOCKERY LANE, RALEIGH, NC, 27606, US

(21) Appl. No.: 12/459,552

(22) Filed: Jul. 2, 2009

(51) Int. Cl. H04L 17/02

(52) U.S. Cl. 341/176

(57) ABSTRACT

In certain embodiments, a remotely controllable television has an energy converter that receives light energy from a laser in a remote controller and converts the light energy to electrical energy. A remote control code interpreter that is receives a turn-on code from the remote controller. The electrical energy from the energy converter is used to supply power to the remote control code interpreter. This abstract is not to be considered limiting, since other embodiments may deviate from the features described in this abstract.

### CROSS REFERENCE TO RELATED DOCUMENTS

This application is related to “Zero Standby Power RF Controlled Device” to Shintani, et. al. filed of even date herewith bearing docket number SY-02279.01 U.S. patent application Ser. No. ______ which is hereby incorporated herein by reference.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

Current remote controlled electronic appliances such as home entertainment devices (e.g., television sets, video disc players and the like) consume a small amount of power when turned “off”. This is because the standard “off” mode for a television (TV) set or the like is more akin to a “standby” mode. This has been found necessary in order to prepare the appliance to be fully powered up by use of a remote controller. Accordingly, the appliance utilizes a small amount of standby power to energize a remote control code receiver. In this manner, when the user presses an “on” or “on/off” button on the remote controller, the appliance's remote control code receiver circuitry is powered up and ready to fully power up the appliance (e.g., the TV set).

Unfortunately, although such remote control code receiver circuitry is very low in power consumption (often in the range of about 100 mWatt), when multiplied by multiple devices within a household and millions of households, the aggregate energy consumption is quite substantial and contributes to the detriment of the environment.

While one can reduce this energy consumption to zero by fully switching off power to the appliance or unplugging the appliance, it seems that few people are actually willing to do so, and doing so eliminates the possibility of remote control power-up.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is an example of a block diagram of a system consistent with certain embodiments of the present invention.

FIG. 2 is an example of a block diagram of a system consistent with certain embodiments of the present invention.

FIG. 3 is an example of a more detailed block diagram of a system consistent with certain embodiments of the present invention.

FIG. 4 is a flow chart of an example process carried out in the controlled appliance consistent with certain embodiments of the present invention.

FIG. 5 is a flow chart of an example process carried out in a remote controller consistent with certain embodiments of the present invention.

FIG. 6 is an illustrative example of multiple targets in a remotely controlled TV device consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment”, “an example”, “an implementation” or similar terms means that a particular feature, structure, or characteristic described in connection with the embodiment, example or implementation is included in at least one embodiment, example or implementation of the present invention. Thus, the appearances of such phrases or in various places throughout this specification are not necessarily all referring to the same embodiment, example or implementation. Furthermore, the particular features, structures, or characteristics may be combined in any suitable manner in one or more embodiments, examples or implementations without limitation.

The term “or” as used herein is to be interpreted as an inclusive or meaning any one or any combination. Therefore, “A, B or C” means “any of the following: A; B; C; A and B; A and C; B and C; A, B and C” . An exception to this definition will occur only when a combination of elements, functions, steps or acts are in some way inherently mutually exclusive.

In accord with certain implementations, a remote controller with a laser can be used to focus enough light energy to drive a micro-switch that allows the power-supply to be turned on and the appliance such as a TV to boot itself. In this manner, projection of remote energy is used to power a device to turn-on.

Certain embodiments address an issue with utilizing a mechanical switch to achieve “true zero power” consumption with a electronics device. If a mechanical switch is used to turn off a device, the remote control is rendered useless in that it cannot be used to turn on the device. The user must press the mechanical switch which is wired or otherwise attached to the appliance. However, as noted above, few are willing to forego the use of a remote controller to control power to their television or other remote control enabled appliances. Certain embodiments enable use of a remote control to turn on a device and still achieve a truly “zero power” consumption state without a mechanical switch or a stored power source that must be charged to power the remote control signal receiver circuitry of the appliance. For purposes of this document, a television set (TV) will be used as an illustrative, but non-limiting example. Other remotely controlled devices could also be used with implementations consistent with the present invention.

In accord with certain implementations, a laser is used to focus power on a light sensor to power the TV to turn on the power-supply. Existing IR/RF technology can still be used once the TV, or at least the remote control code receiver of the TV is turned-on. The laser energy is primarily used in a process to directly or indirectly turn-on the TV. Since the TV will require zero quiescent power to acheive this, this is truly a zero standby power TV.

The laser can focus enough light energy onto the TV to give it energy to drive (power) a circuit that closes a relay or switch (or the functional equivalent). This allows the power supply to be totally turned off, when the TV is powered down, thus turning off all circuitry in the device, and providing a means through the remote control to turn on the power supply. The circuit is activated by optical energy derived from the laser that is coupled in a manner that the circuit is capable of triggering another circuit that enables the power supply to turn itself on. The power supply can then at least power up a remote control code receiver circuit. In other implementations, certain functions of the appliance may be powered during standby (e.g., an internal time clock), but even if the TV power is not reduced to zero, the power can be substantially reduced.

In certain embodiments, laser color could be used to implement other functions such as volume, channel up/down, etc. eliminating the need for a separate IR or RF circuit; or, the laser can be used only for the power on function. This concept is applicable to any device that relies on remote controls or other remote signaling method to turn on or off. Examples are TVs, audio systems, home entertainment systems, or any other type of electrical equipment.

It is noted that conference rooms often have projectors. The projectors have remote control devices, and the remote control devices sometime have lasers to point to presentations on screen. That same laser could serve double duty to be used to turn the projector on. The appliance should have an adequately sized targeting window which make it easy for a person to aim. The targeting window could be in the back of a projector or on the front bezel of a television or other appliance, or remotely situated. It is possible for there to be more than one targeting window, for example, on multiple sides of the appliance.

In addition, it is noted that the use of a laser might provide a convenient way to remote control a single TV in a room full of TVs such as a showroom. The targeting of the TV is very selective since the laser light is very directional.

In one simple implementation, the circuit can be implemented using a light activated thyristor or similar device that could either be provided with an enclosure or light pipe arranged such that ambient light would not be able to readily trigger the device. Only a narrowly focused beam of light would be able to trigger the device. In certain implementations, the laser could also be modulated, so in addition to providing the light energy to power the device, the modulation would provide a secondary level of security, i.e., it would require a specific sequence or information modulated in the laser to activate. This might prevent “ambient light” or sunrays from inadvertently activating the appliance. Other embodiments will occur to those skilled in the art upon consideration of the present teachings.

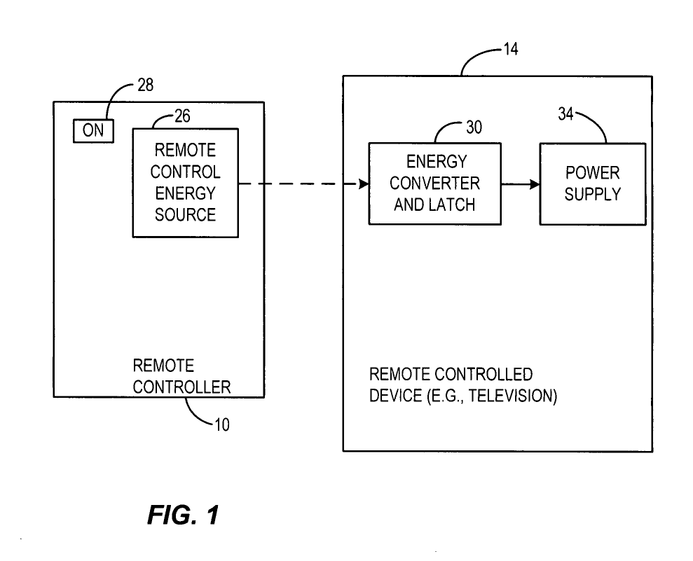

Turning now to FIG. 1, an example embodiment consistent with the invention is depicted in block diagram form. In this example, a remote controller 10 communicates with a television set or other controlled device 14. In accord with certain embodiments, a remote control energy source 26 such as a laser is used to stimulate an energy conversion device (such as a photoelectric circuit element) that then closes a latch at 30. The energy source 26 energizes the energy converter circuit such as a photoelectric element and turns on power supply 34. When the energy converter 30 and its associated latch turns on as a result of being energized by the laser light, power is applied to the remote controlled device 14. The on signal is provided when on button 28 is actuated.

By using the remote laser energy source 26 to power of the energy converter and latch 30, the remote controlled device 14 can be at or near zero with no standby power.

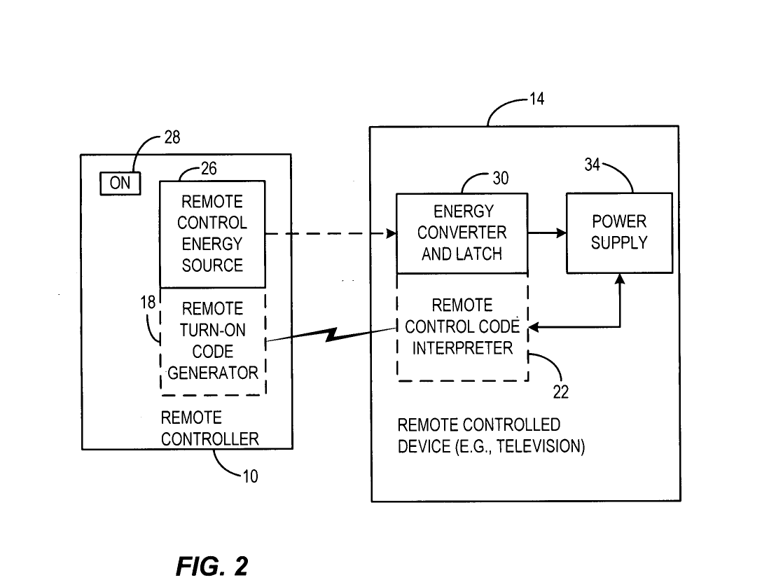

Turning now to FIG. 2, an example embodiment consistent with the invention is depicted in block diagram form. In this example, a remote controller 10 communicates with a television set or other controlled device 14. In certain implementations, multiple coding methods can be used to communicate using either radio frequencies (RF) or InfraRed (IR) signaling in a known manner. This is depicted as turn on code generator 18 and remote control code interpreter or receiver 22. In accord with certain embodiments, a remote control energy source 26 such as a laser is used to stimulate an energy conversion device (such as a photoelectric circuit element) that then closes a latch at 30. In some implementations, coding in the laser light signal can itself be used to avoid false turn-ons (in which case generator 18 modulates the energy source 26 and the energy converter 30 sends information to the interpreter 22), while in other implementations as depicted, a separate RF or IR code can be sent once the energy source 26 energizes the energy converter circuit such as photoelectric element 40. When the energy converter 30 and its associated latch turns on as a result of being energized by the laser light, power is applied to the remote control code interpreter 22 that either interprets coding embedded in the laser light (i.e., modulating the laser light according to a code word or other code) or a separate RF or IR code sent from 18. Once the proper turn-on code is deemed to have been received, the remote control code interpreter 22 sends a control signal to the power supply 34 to turn on the remainder of the circuitry for the controlled device 14.

By using the remote laser energy source 26 to derive enough power to interpret an accompanying (or embedded) code, the power of the remote controlled device can be at or near zero with no standby power being required to keep the remote control code interpreter 22 alive to await a turn-on command. The turn-on code generator 18 and the laser 26 are actuated upon the user depressing a turn-on button 28 (i.e., actuating a turn-on switch—generally a momentary contact switch) as is common on remote controllers.

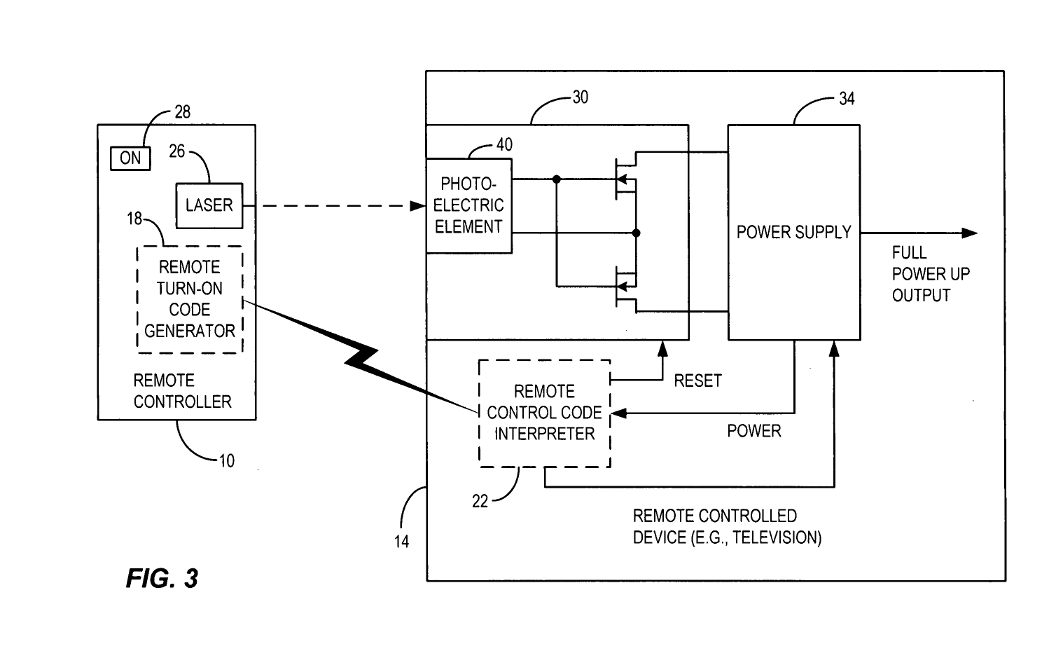

FIG. 3 depicts a more detailed implementation of the circuitry of FIG. 2 wherein the laser 26 is shown to illuminate one or more photoelectric elements 40 (such as laser diodes, solar cells or even potentially a thermocouple or bimetal strip which warms and flexes in response to the laser light in order to either produce electrical output upon being struck by light energy from the laser or directly closing a circuit upon being struck by light energy from the laser). The remote turn-on code generator 18 and the laser 26 are energized to produce a turn on code and laser energy upon actuation of the on switch 28 (or on/off switch). Multiple elements or multiple laser light pathways to a single element can be used to provide a target in multiple places on an appliance upon which the laser can act. In certain implementations, the element or elements can be enclosed within a hood to minimize the likelihood of a stray source of light from energizing the photoelectric element(s) 40. In certain implementations, optical filters can also be used to selectively use only light of proper wavelength for similar purposes.

When the laser light generates energy at the photoelectric element, the latch circuit (shown by example as the interconnected transistor pair) creates a closed switch circuit to the power supply 34, which in turn powers up the remote control code interpreter. The remote control code interpreter 22 then looks to see if it is receiving a valid turn-on code from the remote controller (either as a separate signal or as a signal embedded in the laser signal). If so, a signal is sent to the power supply causing the power supply to energize the remainder of the controlled device 14. But, if no turn-on code is received within an specified time period, the latch in 30 is reset and the power supply powers down the remote control code interpreter.

In this example, the laser light shines on the photo-sensitive element to produce a voltage between the MOSFET source and its gate, causing the MOSFET to turn on. A single MOSFET, or multiple MOSFETs in a paralleled array can be used to control the power supply. The photo-sensitive element can be a photo-sensitive diode, solar cell, etc. The photo-sensitive element can be used to turn on back to back thyristors, silicon controlled rectifiers or transistors such as MOSFET transistors to switch the load. Other variations are also possible.

It is noted that in modern digital television sets, their complexity often dictates that they carry out a boot-up cycle that can take several seconds. An impatient user may execute the turn-on button multiple times until he becomes accustomed to the delay in turn-on. Hence, in certain implementations, if the “on” button also serves as an “off” button, it may be desirable for the system to lock out an “on/off” command until a period of time after completion of boot up of the device—for example, without intent of limitation, a 2-4 second delay.

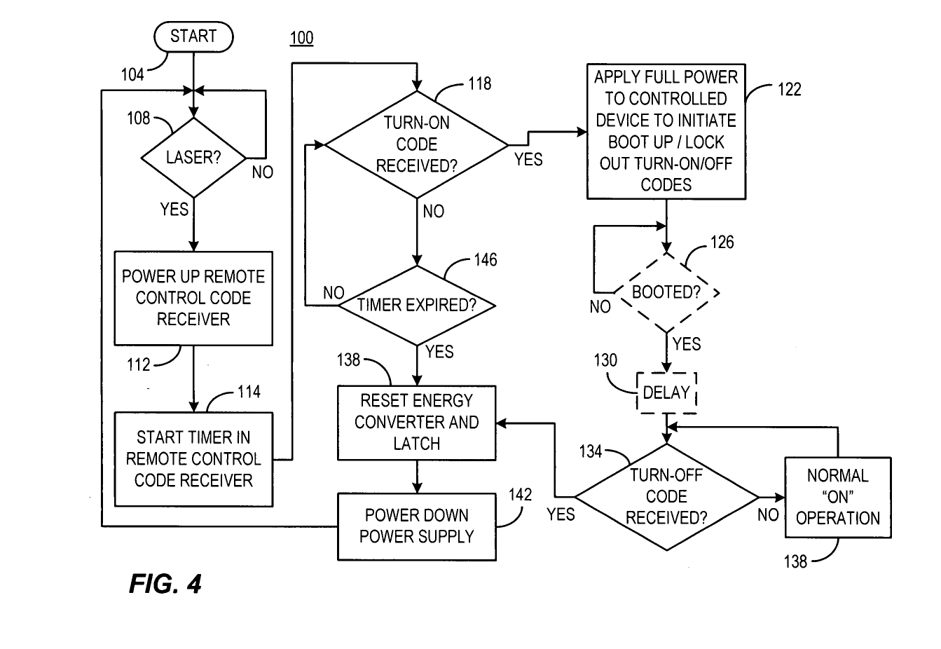

FIG. 4 depicts operation of the controlled device 14 such as a TV set as process 100 starting at 104. When the photoelectric element 40 detects laser light of high enough energy to trip the latch in 30 (in a manner similar to a solid state relay), the power supply 34 is turned on to the remote control receiver at 112 and a timer starts in the remote control code receiver/interpreter 22 at 114. The remote control code receiver then looks for a turn-on code either embedded in the laser signal or as a separate IR or RF signal at 118. If one is received during the time period established by the timer at 118, the full power is applied to the controlled device at 122.

As noted earlier, it may be desirable to assure that multiple attempts at turn-on do not inadvertently result in turn-off before booting is complete. So, at 126 a check is made to determine if the TV is booted and if so, a delay is imposed at 130 of perhaps several seconds until receipt of a turn-off code is acceptable at 134. If no turn-off code is received, the controlled device operates with its normal “on” operation at 138 until a turn-off code is received at 134.

If a turn-off code is received at 134, it is not necessary for the laser to energize the photoelectric element since full power is available, in the preferred embodiment. Once the turn-off code is received at 134, the latch in 30 is reset at 138 and the power supply is powered down at 142 and the process returns to 108 to await the next turn-on signal.

In the event a turn-on code is not received at 118 prior to expiration of the timer started at 114 at 146, control passes to 138 since the turn-on is assumed to be a false power-up of the control code receiver. This resets the latch and powers down the power supply to await the next turn-on.

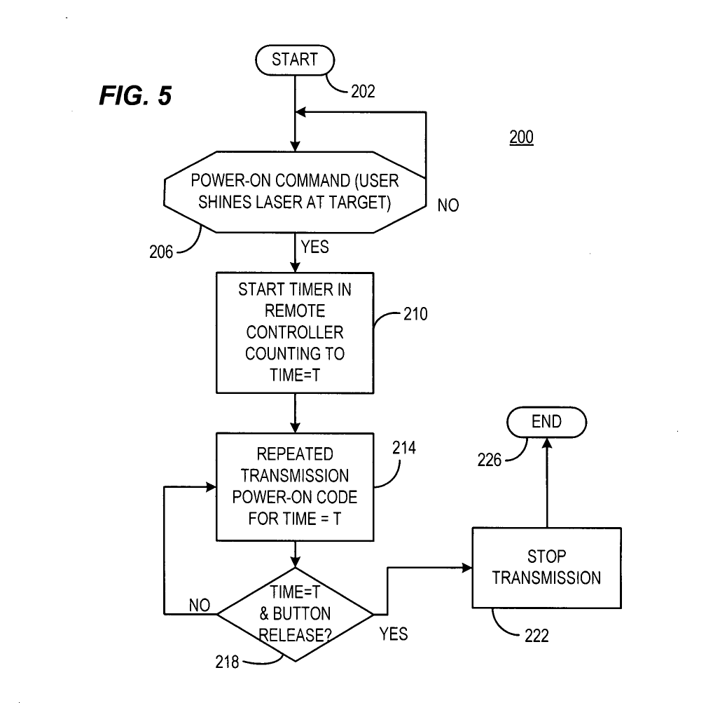

FIG. 5 depicts a process 200 in flow chart form describing the operation of the remote controller 10 in the process of turning on the remotely controlled device 14 starting at 202. The user points the laser at a target on the controlled device (e.g., TV) at 206. A timer is started either upon turning on the laser or upon release of the “on” button at 210 to establish a time period during which the remote controller will send several turn-on codes over a period of time (or count of the number of turn-on codes) at 214. When both the “on” button is released and the time T has expired (or count of turn-on codes) at 218, transmission is halted at 222 and the process ends at 226. Many variations are possible, including two way communication to acknowledge receipt of the turn-on signal and the like without departing from embodiments consistent with the present invention.

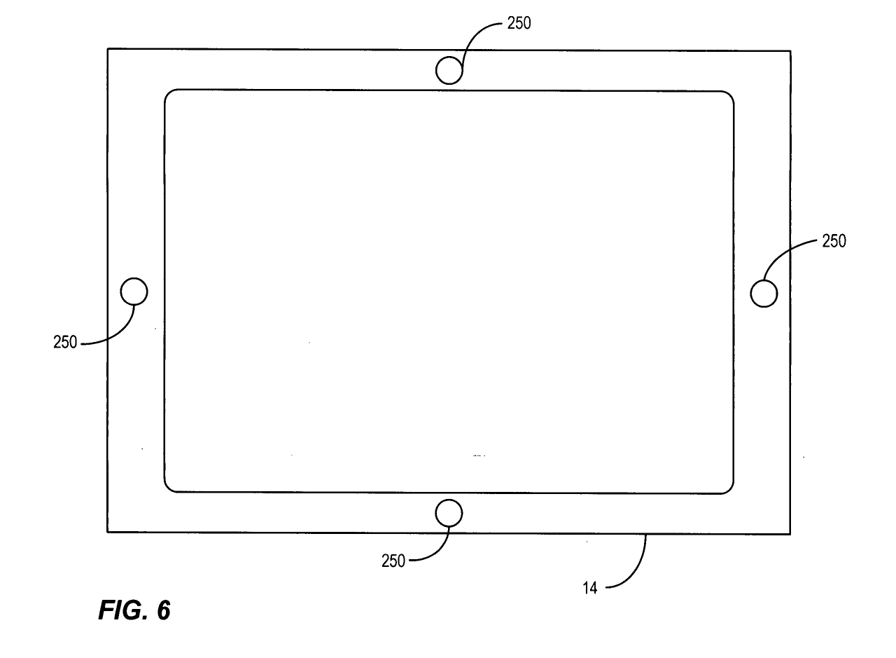

FIG. 6 depicts multiple targets 250 on the perimeter of a TV display so that the user can direct the laser to any convenient target. The targets can include either multiple parallel sensors, or light guides to a single sensor. Additionally, the targets can be embedded into the surface and/or optically filtered to minimize falsely interpreting various lighting conditions as a turn-on laser signal. One may optionally provide for sensitivity adjustment to minimize such falsing or provide a remotely situated target that is electrically tethered to the TV 14. Other variations will occur to those skilled in the art upon consideration of the present teachings.

Thus, an electronic appliance remote controller consistent with certain implementations has a user actuatable turn-on switch. A laser light source turns on a laser light in response to user actuation of the turn-on switch. A code generator generates and transmits a turn-on code in response to a user actuating the turn-on switch. The code generator and the laser light source in combination cause a controlled device to turn on.

In certain implementations, the code generator modulates the laser light in response to the user actuation of the turn-on switch. In certain implementations, the code generator modulates an infrared light source in response to the user actuation of the turn-on switch. In certain implementations, the code generator modulates a radio frequency signal source in response to the user actuation of the turn-on switch. In certain implementations, a timer is provided and the code generator generates the turn-on code for a time period established by the timer. In certain implementations, a counter is provided and the code generates a specified number of counts of the turn-on code as established by the counter. In certain implementations, the remote controller is configured to control a television set.

Another implementation of a television set remote controller has a user actuatable turn-on switch. A laser light source turns on a laser light in response to user actuation of the turn-on switch. A code generator generates a repeating sequence of turn-on codes in response to a user actuating the turn-on switch, where the code generator modulates at least one of the laser light source, an infrared light source and a radio frequency light source as a result of the user actuating the turn-on switch. The code generator and the laser light source in combination cause a controlled device to turn on.

A remotely controllable television consistent with certain embodiments has an energy converter that receives light energy from a laser in a remote controller and converts the light energy to electrical energy. A remote control code interpreter receives a turn-on code from the remote controller. The electrical energy from the energy converter is used to supply power to the remote control code interpreter.

In certain implementations, the electrical energy is supplied to the remote control code interpreter from a power source that is activated by the energy converter. In certain implementations, the turn-on code is received within a specified time period of actuation of the control code interpreter. In certain implementations, upon receipt of the turn-on code, a power source is activated to energize the television. In certain implementations, one or more targets are provided that receive the laser light and channel the laser light to the energy converter.

Another implementation of a remotely controllable television has an energy converter that receives light energy at a target from a laser in a remote controller and converts the light energy to electrical energy and a power source. A remote control code interpreter receives a turn-on code from the remote controller, where the electrical energy is supplied to the remote control code interpreter from a power source that is activated by the energy converter. The turn-on code is received within a specified time period of actuation of the control code interpreter. The electrical energy from the energy converter is used to supply power to the remote control code interpreter and where upon receipt of the turn-on code, the power source is activated to energize the television.

Certain embodiments described herein, are or may be implemented using a hardware or software processor executing programming instructions that are broadly described above in flow chart form that can be stored on any suitable tangible electronic or computer readable storage medium. However, those skilled in the art will appreciate, upon consideration of the present teaching, that the processes described above can be implemented in any number of variations without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. An electronic appliance remote controller, comprising:
a user actuatable turn-on switch;
a laser light source that turns on a laser light in response to user actuation of the turn-on switch;
a code generator that generates a turn-on code in response to a user actuating the turn-on switch; and
whereby the code generator and the laser light source in combination cause a controlled device to turn on.

2. The electronic appliance remote controller according to claim 1, where the code generator modulates the laser light in response to the user actuation of the turn-on switch.

3. The electronic appliance remote controller according to claim 1, where the code generator modulates an infrared light source in response to the user actuation of the turn-on switch.

4. The electronic appliance remote controller according to claim 1, where the code generator modulates a radio frequency signal source in response to the user actuation of the turn-on switch.

5. The electronic appliance remote controller according to claim 1, further comprising a timer and where the code generator generates the turn-on code for a time period established by the timer.

6. The electronic appliance remote controller according to claim 1, further comprising a counter and where the code generates a specified number of counts of the turn-on code as established by the counter.

7. The electronic appliance remote controller according to claim 1, wherein the remote controller is configured to control a television set.

8. A television set remote controller, comprising:
a user actuatable turn-on switch;
a laser light source that turns on a laser light in response to user actuation of the turn-on switch;
a code generator that generates a repeating sequence of turn-on codes in response to a user actuating the turn-on switch, where the code generator modulates at least one of the laser light source, an infrared light source and a radio frequency light source as a result of the user actuating the turn-on switch;
whereby the code generator and the laser light source in combination cause a controlled device to turn on.

9. A remotely controllable television, comprising:
an energy converter that receives light energy from a laser in a remote controller and converts the light energy to electrical energy;
a remote control code interpreter that receives a turn-on code from the remote controller; and
where the electrical energy from the energy converter is used to supply power to the remote control code interpreter.

10. The remotely controllable television according to claim 9, where the electrical energy is supplied to the remote control code interpreter from a power source that is activated by the energy converter.

11. The remotely controllable television according to claim 9, where the turn-on code is received within a specified time period of actuation of the control code interpreter.

12. The remotely controllable television according to claim 9, where upon receipt of the turn-on code, a power source is activated to energize the television.

13. The remotely controllable television according to claim 9, further comprising one or more targets that receive the laser light and channel the laser light to the energy converter.

14. A remotely controllable television, comprising:
an energy converter that receives light energy at a target from a laser in a remote controller and converts the light energy to electrical energy;
a power source;
a remote control code interpreter that receives a turn-on code from the remote controller, where the electrical energy is supplied to the remote control code interpreter from a power source that is activated by the energy converter;
where the turn-on code is received within a specified time period of actuation of the control code interpreter; and
where the electrical energy from the energy converter is used to supply power to the remote control code interpreter and where where upon receipt of the turn-on code, the power source is activated to energize the television.

15. An electronic appliance remote controller, comprising:
a user actuatable turn-on switch;
a laser light source that turns on a laser light in response to user actuation of the turn-on switch;
whereby the laser light source powers a circuit in a controlled device in order to turn it on.

16. The electronic appliance remote controller according to claim 15, further comprising a code generator that modulates the laser light in response to the user actuation of the turn-on switch.

17. The electronic appliance remote controller according to claim 15, further comprising a code generator modulates an infrared light source in response to the user actuation of the turn-on switch.

18. The electronic appliance remote controller according to claim 15, further comprising a code generator that modulates a radio frequency signal source in response to the user actuation of the turn-on switch.

19. The electronic appliance remote controller according to claim 1, further comprising a timer and a code generator, wherein the code generator generates a turn-on code for a time period established by the timer.

20. The electronic appliance remote controller according to claim 1, further comprising a counter and a code generates that generates a specified number of counts of a turn-on code as established by the counter.

21. The electronic appliance remote controller according to claim 1, wherein the remote controller is configured to control a television set.
